(19) United States
(12) Patent Application Publication
(10) Pub. No.: US 2014/0111849 A1
(43) Pub. Date: Apr. 24, 2014

(54) APPARATUS AND METHOD FOR MOSAIC GRATINGS-BASED POLARIZER

(71) Applicant: POLARIZATION SOLUTIONS, LLC, Somerset, NJ (US)

(72) Inventors: Deng Xuegong, Piscataway, NJ (US); Shiaw-Wen Tai, Livingston, NJ (US); Denis Pristinski, Dublin, CA (US); Atsuo Kuki, Frederick, MD (US)

(21) Appl. No.: 13/839,083

(22) Filed: Mar. 15, 2013

Related U.S. Application Data
(60) Provisional application No. 61/715,667, filed on Oct. 18, 2012.

(51) Int. Cl. G02B 7/00; G02F 1/13; G02B 5/30

(52) U.S. Cl. CPC G02B 7/003; G02B 5/3058; G02B 5/3075; G02F 1/1303
USPC 359/352; 359/483.01

(57) ABSTRACT

A polarizer may be flexibly mounted within a frame to yield. The polarizer may then be handled, within the frame, without directly contacting the polarizer. A plurality of such frame-mounted polarizers may be combined in a tray in which they are aligned to form a mosaic polarizer that may be configured as a one-dimensional, linear, polarizer array or a two-dimensional, rectangular, polarizer array.

### CROSS-REFERENCE TO RELATED APPLICATIONS

This US non-provisional patent application claims priority under 35 USC §119(e) to U.S. Provisional Patent Application entitled, “Large-Format, Mosaic Gratings-Based Polarizer, Apparatus And Methods Of Making,” having Ser. No. 61/715,667 filed on Oct. 18, 2012, the entirety of which is hereby incorporated by reference.

### BACKGROUND OF THE INVENTION

Inventive concepts relate to polarizers and, more particularly, to large format polarizers.

Polarizers may be used for a variety of tasks, including, but not limited to, photo-alignment of liquid crystal panels. Photo-alignment of liquid crystal panels is known and described, for example, in U.S. Pat. No. 4,974,941, which is hereby incorporated by reference. Because photo-alignment is a non-contact process, panels are not damaged as they might be when using mechanical alignment processes. Additionally, debris associated with a mechanical alignment process is neither produced nor deposited by a photo-alignment process. However, conventional polarizers, and systems, such as irradiation systems, that employ them, may require complex beam shaping and correction. An apparatus and method that eliminates or reduces the need for such beam shaping and correction would therefore be highly desirable.

### SUMMARY OF THE INVENTION

Exemplary embodiments in accordance with principles of inventive concepts include a frame-mounted polarizer that includes: a polarizer; a frame; and a flexible mount coupling the polarizer to the frame.

In an exemplary embodiment in accordance with principles of inventive concepts, the flexible mount comprises an expansion mechanism to apply force to at least one side of the polarizer and to thereby secure, or restrict movement of, the polarizer within the frame.

In an exemplary embodiment in accordance with principles of inventive concepts, the polarizer is a grating polarizer or wire-grid polarizer.

In an exemplary embodiment in accordance with principles of inventive concepts, the polarizer is an ultraviolet polarizer.

In an exemplary embodiment in accordance with principles of inventive concepts, a frame-mounted polarizer includes retention elements to position the polarizer within the frame.

In an exemplary embodiment in accordance with principles of inventive concepts, an expansion mechanism includes a spring in compression configured to apply a force to the polarizer and to thereby hold the polarizer against the frame.

In an exemplary embodiment in accordance with principles of inventive concepts, a frame-mounted polarizer includes a clamp to hold a side of the polarizer opposite the side of the polarizer to which the spring force is applied, and to thereby secure the polarizer within the frame.

In an exemplary embodiment in accordance with principles of inventive concepts, a mosaic polarizer array includes a rigid tray to accept frame-mounted polarizers; a plurality of frame-mounted polarizers affixed to the tray, wherein each frame-mounted polarizer includes: a polarizer; a frame; and a flexible mount coupling the polarizer to the frame.

In an exemplary embodiment in accordance with principles of inventive concepts, the flexible mount comprises an expansion mechanism to apply force to at least one side of the polarizer and to thereby secure the polarizer within the frame.

In an exemplary embodiment in accordance with principles of inventive concepts, the polarizer is a grating polarizer.

In an exemplary embodiment in accordance with principles of inventive concepts, the polarizer is an ultraviolet polarizer.

In an exemplary embodiment in accordance with principles of inventive concepts, a mosaic polarizer array includes retention elements to position the polarizer within the frame.

In an exemplary embodiment in accordance with principles of inventive concepts, the expansion mechanism includes a spring in compression configured to apply a force to the polarizer and to thereby hold the polarizer against the frame.

In an exemplary embodiment in accordance with principles of inventive concepts, a mosaic polarizer array includes a clamp to hold a side of the polarizer opposite the side of the polarizer to which the spring force is applied, and to thereby secure the polarizer within the frame.

In an exemplary embodiment in accordance with principles of inventive concepts, the frame-mounted polarizers are aligned within the rigid tray.

In an exemplary embodiment in accordance with principles of inventive concepts, the rigid tray accommodates a one-dimensional, linear array of frame-mounted polarizers.

In an exemplary embodiment in accordance with principles of inventive concepts, the rigid tray accommodates a two-dimensional, rectangular array of frame-mounted polarizers.

In an exemplary embodiment in accordance with principles of inventive concepts, an irradiation device includes a light source; a housing including a reflector; and a mosaic polarizer positioned within the housing, with the light source between itself and the reflector, the mosaic polarizer comprising: a rigid tray to accept frame-mounted polarizers; a plurality of frame-mounted polarizers affixed to and aligned within the tray, wherein each frame-mounted polarizer includes: a polarizer; a frame; and a flexible mount coupling the polarizer to the frame.

In an exemplary embodiment in accordance with principles of inventive concepts, the light source is an ultraviolet light source and the polarizers are ultraviolet polarizers.

In an exemplary embodiment in accordance with principles of inventive concepts, the mosaic polarizer includes a one-dimensional linear array of frame-mounted polarizers.

### BRIEF DESCRIPTION OF THE DRAWINGS

Exemplary embodiments in accordance with principles of inventive concepts will be more clearly understood from the following detailed description taken in conjunction with the accompanying drawings in which:

FIGS. 1a though 1f are schematic illustrations of exemplary embodiments of frame-mounted polarizers in accordance with principles of inventive concepts;

FIGS. 2a though 2d(3) are schematic illustrations of mosaic array polarizers, including frame-mounted polarizers in accordance with principles of inventive concepts;

FIGS. 3a and 3b are schematic illustrations of exemplary embodiments of irradiation devices in accordance with principles of inventive concepts;

FIG. 4 is a flow chart depicting a process of assembling and aligning a mosaic array polarizer in accordance with principles of inventive concepts’

FIGS. 5 through 10 are schematic representations of a process of aligning a mosaic array polarizer in accordance with principles of inventive concepts.

### DETAILED DESCRIPTION

Exemplary embodiments in accordance with principles of inventive concepts will now be described more fully with reference to the accompanying drawings, in which exemplary embodiments are shown. Exemplary embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of exemplary embodiments to those of ordinary skill in the art. In the drawings, the thicknesses of layers and regions may be exaggerated for clarity. Like reference numerals in the drawings denote like elements, and thus their description may not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “bottom,” “below,” “lower,” or “beneath” other elements or features would then be oriented “atop,” or “above,” the other elements or features. Thus, the exemplary terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which exemplary embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein. Although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

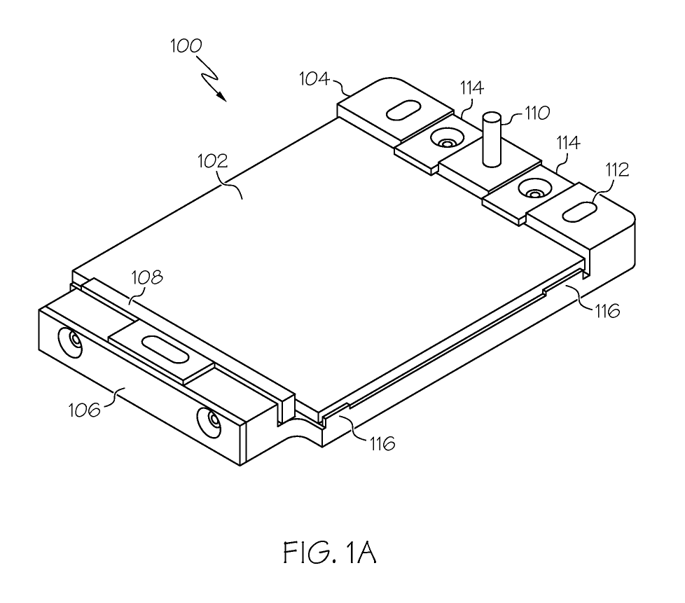

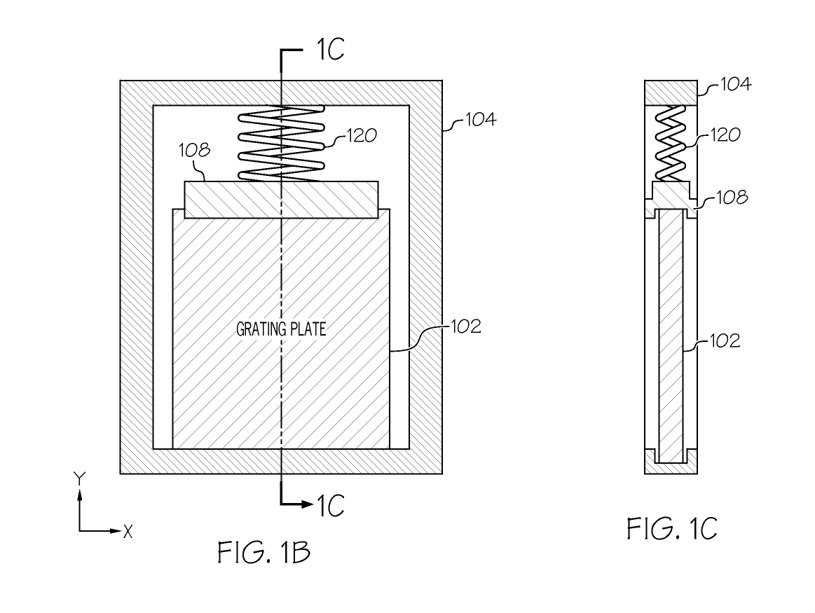

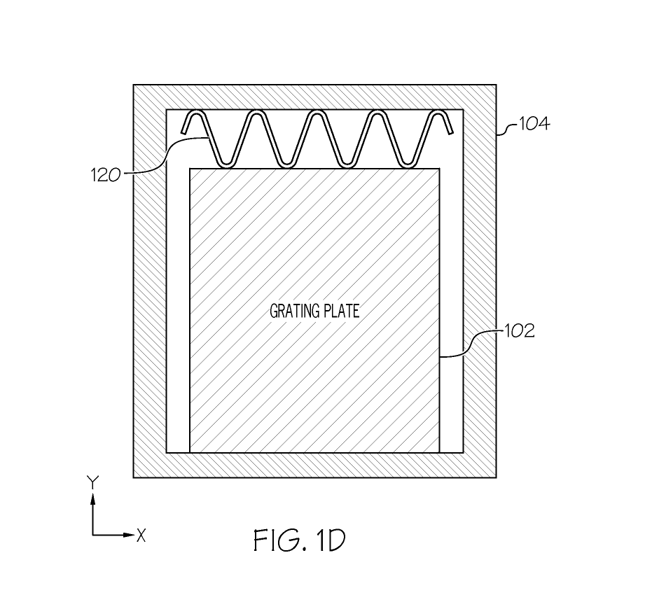

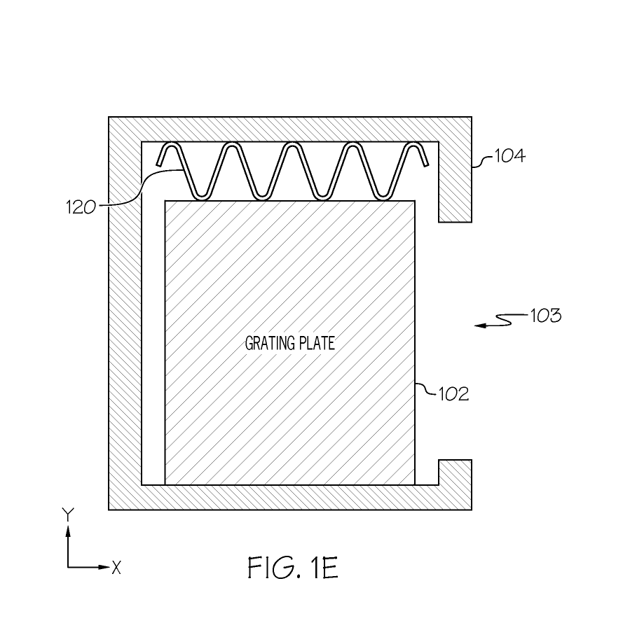

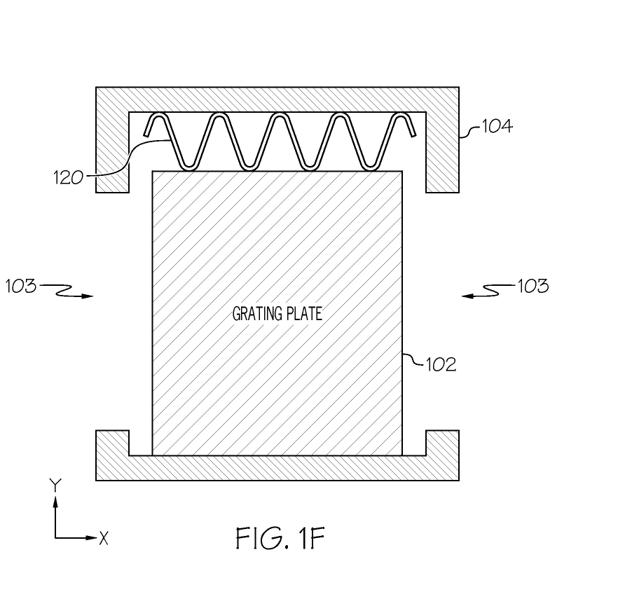

An exemplary embodiment of a mounted polarizer (also referred to herein as a grating) 100, in accordance with principles of inventive concepts is illustrated in FIGS. 1a through 1f. In accordance with principles of inventive concepts, the mounted polarizer 100 may be combined with other mounted polarizers to form a large-format mosaic grating-based polarizer. In accordance with principles of inventive concepts, the mounted polarizer may be an ultraviolet polarizer (UVP) featuring large acceptance angles. By large acceptance angles we mean an ultraviolet polarizer that provides at least 10 dB of extinction at at least one wavelength in the UV range (wavelength <400 nm) and that the extinction is 10 dB or more at at least one wavelength in the range of 100-400 nm over an angle of incidence range of at least ±10 deg., or, in other exemplary embodiments ±20 deg., or, in other exemplary embodiments, ±30 deg., or ±60 deg.. Examples of such polarizers include those described in United States Patent Office published applications 20090053655 and 20090041971, which are hereby incorporated by reference.

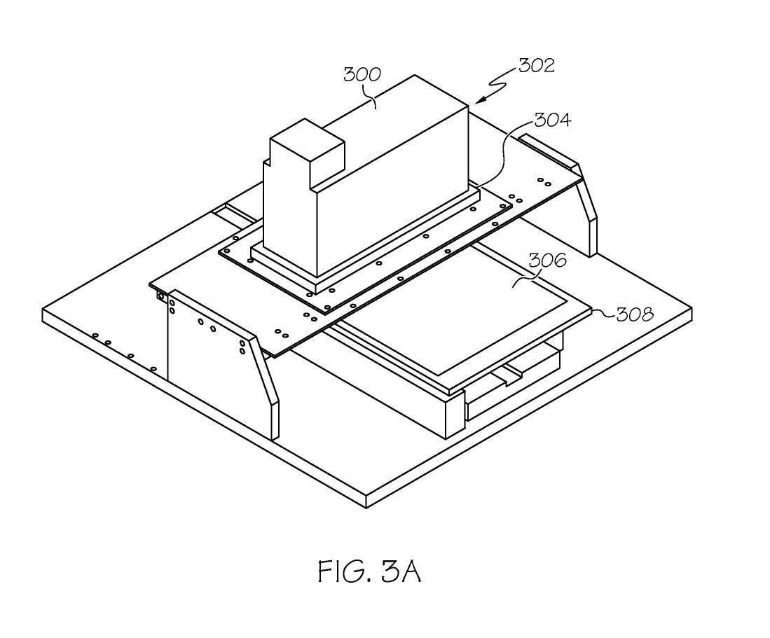

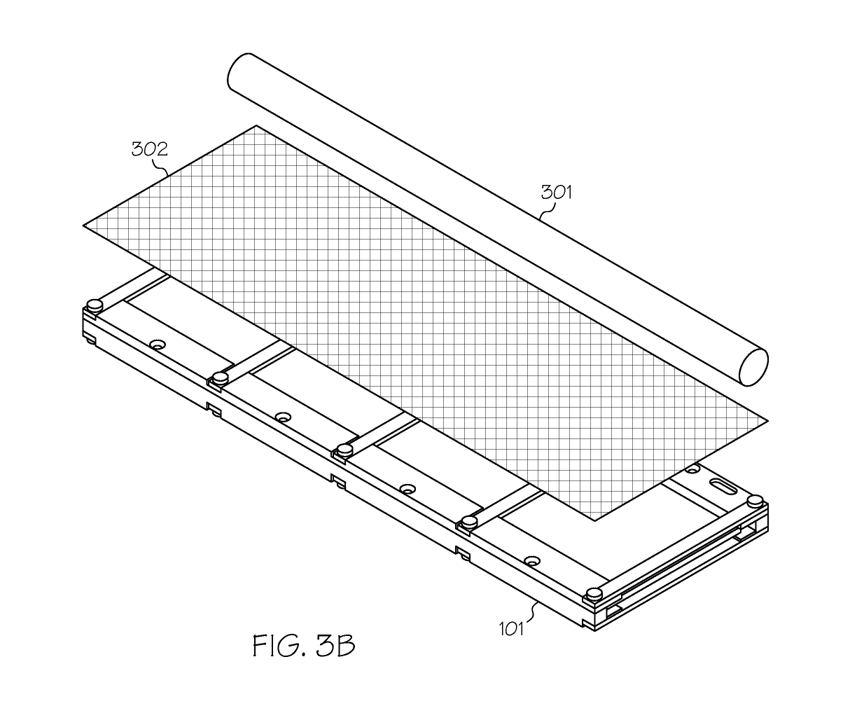

A large-format mosaic gratings-based polarizer in accordance with principles of inventive concepts may be employed in a large format irradiation device, for example. Because it employs large-acceptance angle ultraviolet polarizers, a large format irradiation device in accordance with principles of inventive concepts may require no beam shaping or correction. As a result, a large format irradiation device in accordance with principles of inventive concepts may be formed, simply, as will be described in greater detail in the discussion related to FIGS. 3a and 3b, with an ultraviolet light source, an elliptical reflector, and large format mosaic gratings-based polarizer in accordance with principles of inventive concepts.

FIG. 1a illustrates an exemplary embodiment of a mounted polarizer 100 in accordance with principles of inventive concepts. In accordance with principles of inventive concepts a mounted polarizer may include a wide acceptance angle polarizer positioned in a mount, also referred to herein as a tray, that allows for fine adjustments of the polarizer's orientation without directly contacting the polarizer. In exemplary embodiments in accordance with principles of inventive concepts, the mount includes a retaining device and a compression-fit mechanism, such as a spring-loaded pressure bar, for example, to hold the polarizer in place within the mount. In accordance with principles of inventive concepts, a plurality of mounted polarizers 100 may be combined in a holder, or frame, to form a large-format mosaic polarizer. Each mounted polarizer may be loaded into the frame and aligned within the frame to a predefined angle value θ₀ with tolerance of ±0.5 deg., or, in other exemplary embodiments, to within ±0.2 deg., or, in other exemplary embodiments, to within ±0.1 deg, or to within ±0.01 deg, with respect to the frame. θ₀ may take any value. By orientation “with respect to the frame,” we mean that the gratings of the polarizer are aligned with respect to reference edge, such as a parallel edge, or orthogonal edge, of the frame. Additionally, in accordance with principles of inventive concepts, polarizers may be aligned with respect to one another to within ±0.5 deg., or, in other exemplary embodiments, to within ±0.2 deg., or, in other exemplary embodiments, to within ±0.1 deg., or to within ±0.01 deg. In accordance with principles of inventive concepts, a plurality of mounted polarizers may be combined and aligned in linear or rectangular formats to yield large-format mosaic polarizer arrays, which may be in excess of a meter in length and/or width. Because the polarizers are mounted and the mounts are placed in rigid frames and aligned, little or no force need be imparted to the polarizers themselves during mounting or alignment. Once aligned, the mounts, and the polarizers which they hold, may be locked in place for operation.

In the exemplary Mounted polarizer 100 includes a polarizer 102, which, in accordance with principles of inventive concepts, may be an ultraviolet polarizer featuring wide acceptance angles, for example. The polarizer 102 is mounted in a frame 104 (also referred to herein as mount 104). End cap 106 retains a compression element (not shown in this view), such as a spring, for applying pressure to, and thereby retaining, polarizer 102. The compression element forces polarizer 102 against the opposite side of frame opening (that is, the side where slab clamps 114 are located). Pushing bar 108 directs force supplied by the compression element to one end of polarizer 102. Pushing bar 108 may include flanges configured to engage with either side of polarizer 102 and the thereby ensure the stability of polarizer 102, once it is mounted in frame 104. Slab clamps 114 retain polarizer 102 at the opposite end. Retention elements 116 restrict movement of polarizer 102 in the transverse direction. Mounting holes 112 and mounting pin 110 are used to align and fix the mounted polarizer 100 in a frame to form a large-format mosaic gratings based polarizer in accordance with principles of inventive concepts. Retention elements 116 may be vertical tabs, for example, that limit lateral shift of polarizer 102 to less than 1 mm, or, in another exemplary embodiment in accordance with principles of inventive concepts, to less than 0.5 mm, or to less than 0.2 mm.

The schematic diagram of FIG. 1b illustrates a mounted polarizer 100 in accordance with principles of inventive concepts. In this exemplary embodiment spring 120 exerts a retaining force normal to one edge of polarizer 102, transferred through push bar 108, to retain polarizer 102 (also referred to herein as grating plate 102) within frame 104 and restrict movement in the XY direction. FIG. 1c provides a sectional view along reference line A-A′ of FIG. 1b.

The schematic diagram of FIG. 1d illustrates a mounted polarizer 100 in accordance with principles of inventive concepts. In this exemplary embodiment spring 120 exerts a retaining force normal to one edge of polarizer 102, through multiple loading points (that is, through points of contact with polarizer 102), to retain polarizer 102 within frame 104 and to thereby restrict movement in the XY direction.

The schematic diagram of FIG. 1e illustrates a mounted polarizer 100 in accordance with principles of inventive concepts. In this exemplary embodiment spring 120 exerts a retaining force normal to one edge of polarizer 102, through multiple loading points, to retain polarizer 102 within frame 104 and restrict movement in the XY direction. In this exemplary embodiment frame 104 is open on one side. Opening 103 may be used to add a mechanical component to enhance rigidity of the common frame or to control light impinging on mounted polarizer 100 or associated devices, for example.

The schematic diagram of FIG. 1f illustrates a mounted polarizer 100 in accordance with principles of inventive concepts. In this exemplary embodiment spring 120 exerts a retaining force normal to one edge of polarizer 102, through multiple loading points, to retain polarizer 102 within frame 104 and restrict movement in the XY direction. In this exemplary embodiment, frame 104 is open on two sides. Openings 103 may be used to add mechanical components to enhance rigidity of the common frame or to control light impinging on mounted polarizer 100 or associated devices, for example.

Although previous embodiments have employed springs as compression members to retain polarizer 102 within frame 104, other means of retaining plate 102, such as flexures, for example, are contemplated in accordance with principles of inventive concepts.

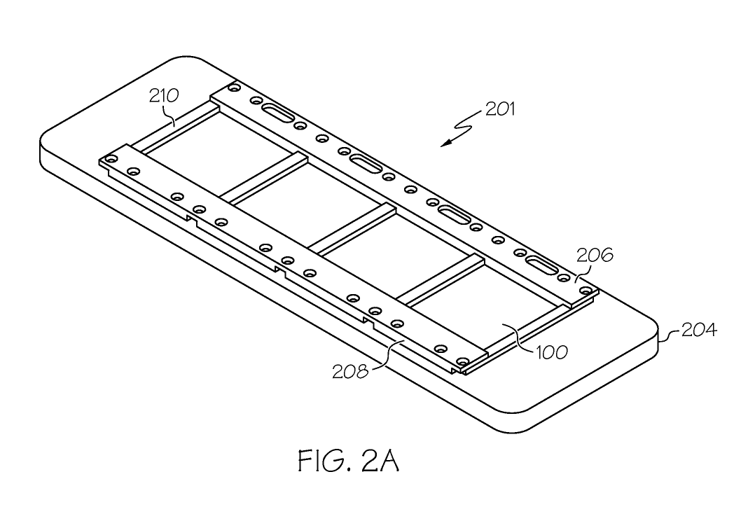

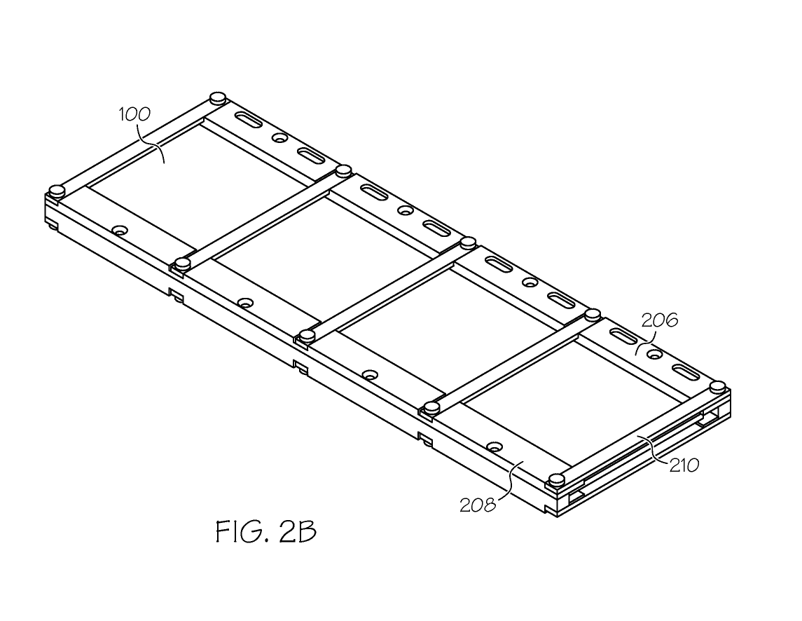

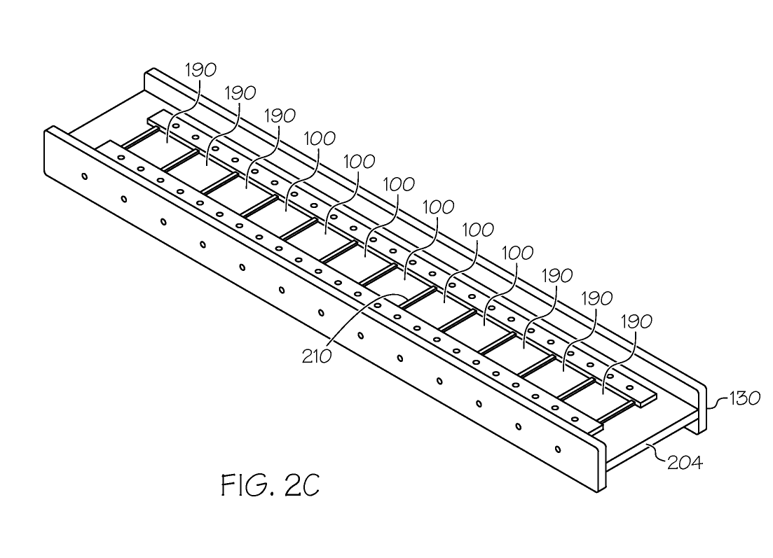

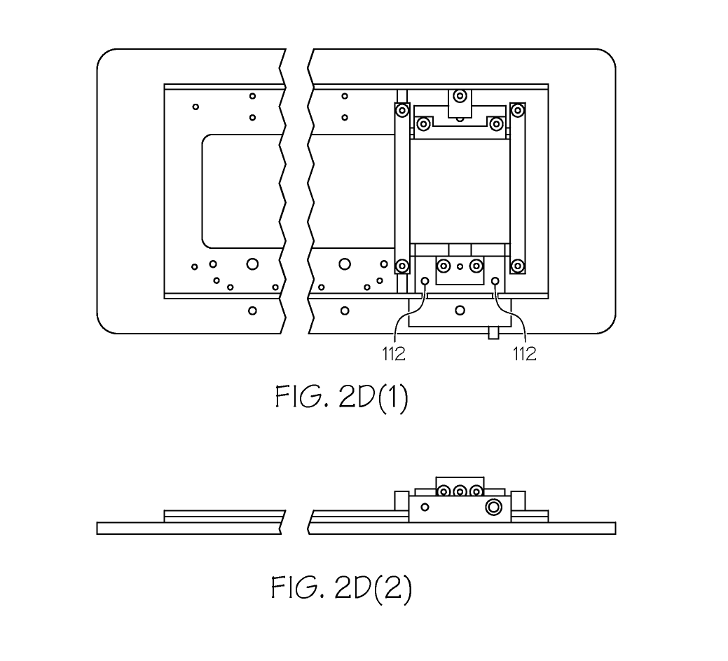

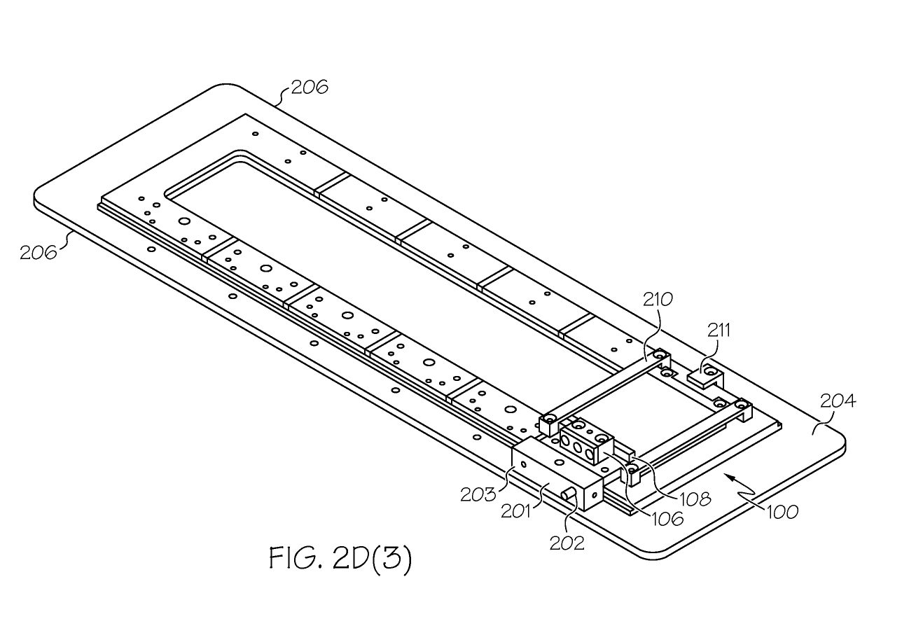

In the exemplary embodiment of FIG. 2a four frame-mounted polarizers 100 mounted within tray 204 are mounted in a side-by-side, or one-dimensional, array, also referred to herein as a mosaic polarizer array tray (PAT) 201. Covering bars, 206, 208 and 210 operate to shield light so that little or no light passes through the tray assembly 201, thereby allowing for cooler operation of a system employing tray assembly 201. In accordance with principles of inventive concepts, tray 204 may be formed of a single solid piece, for example.

In the exemplary embodiment of FIG. 2b, frame-mounted polarizers 100 are combined in a tray to form a linear polarizer array in accordance with principles of inventive concepts. In this exemplary embodiment, cover plates 206, 208, and 210 may operate to limit the passage of light and to, for example, thereby reduce the operating temperature of a system that employs mosaic polarizer 201. Cover plates 206, 208, and 210 may be metal or ceramic plates, for example. A polarizer array tray assembly 201 according to this exemplary embodiment may be joined, end-to-end, with other tray assemblies 201 to form arrays of greater extent. In accordance with principles of inventive concepts, a joint may be formed using cover plates 210 having receptacles configured to join two ends of an array 201. In accordance with principles of inventive concepts, once polarizers are mounted and aligned in a tray 100, they may be combined to faun larger arrays without additional alignment. In accordance with principles of inventive concepts, polarizer array trays 100 may also be combined in two dimensions to form extended rectangular polarizer array trays.

In the exemplary embodiment of a polarizer array in accordance with principles of inventive concepts of FIG. 2c, a plurality of frame-mounted polarizers 100 are combined in a common tray. In this exemplary embodiment, six adjacent frame-mounted polarizers 100 are aligned within tray 204. Masking components 190 on either side of polarizers 100 may be covered with light shields that prevent passage of light, much as shields 210 do. Masking areas may employ the same material, metal or ceramic, for example, as shields 210. In accordance with principles of inventive concepts, masking areas may be used for future expansion of polarization areas. That is, a tray 204 may be constructed with a predetermined number of openings available for frame-mounted polarizers 100, but, depending upon application requirements, only a portion of the slots may be filled with polarizers 100; the other available openings may be filled with masking components 190. In an exemplary embodiment in accordance with principles of inventive concepts, a rigidity member 130 may be added to tray 204 to enhance its rigidity.

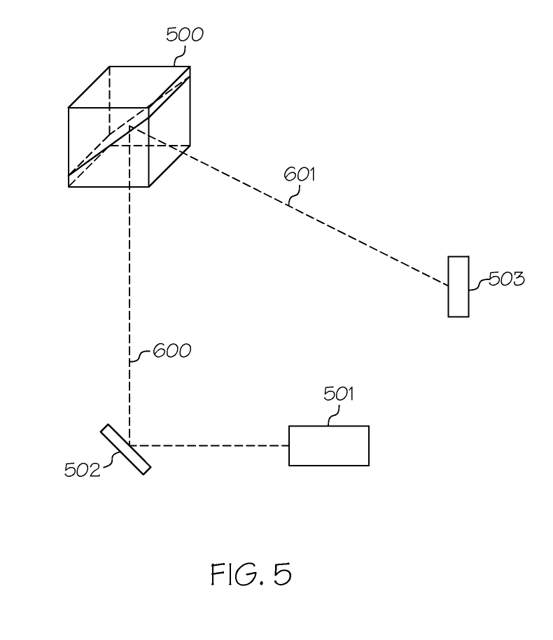

In the exemplary embodiment of FIG. 2d, a frame-mounted polarizer 100 is shown mounted on tray 204. A clamp 211 assists in securing frame-mounted polarizer 100 to tray 204. In accordance with principles of inventive concepts, one side of frame 204, for example side 205 or side 206, may be used as a reference plane for alignment orientation, as described in greater detail in the discussion related to FIGS. 5-10. Adjusters 202 and 203, which may be implemented, for example, as screws or micrometers, may be manipulated to adjust the orientation of frame-mounted polarizer 100 during an alignment process. Once aligned, locking mechanism 112, which may be implemented as one or more set screws, for example, may be employed to fix frame-mounted polarizer 100 in place within frame 204. After alignment and locking, alignment block 210 may be left in place, or removed.

An exemplary embodiment of a photo-alignment system in accordance with principles of inventive concepts is illustrated in the schematic diagrams of FIGS. 3a and 3b. Such a system may be used, for example, to align liquid crystals panels. Such panels may be used in liquid crystal displays, for example. Photoalignment of such panels provides advantages over conventional buffing processes, such as the elimination of particulate contamination of the panels and uneven, imprecise alignment.

In the exemplary embodiment of FIG. 3a, a light source, such as an ultraviolet light source, is positioned within housing 300. Optical devices 302 such as bandpass filters, hot mirrors, or diffractive optics, for example, may be positioned within the housing between the light source and mosaic polarization array 304. Samples 306, such as liquid crystal panels, may be positioned beneath the polarization array tray 304 on holder 308 and irradiated for photoalignment, for example. Housing 300 ensures that light emitted by the light source must travel though the polarizers in the array before it reaches sample 306. In accordance with exemplary embodiments in accordance with principles of inventive concepts, a tray 204 including frame-mounted polarizers in accordance with principles of inventive concepts may be oriented so that the polarization orientation of the frame-mounted polarizers 100 is known with respect to at least one fixture or orientation in the system. There may be translation stages and/or rotation stages disposed on a side of the tray 204, the orientation(s) of which may be known. For example, one orientation mark on the panel may be orientated 15 deg. with respect to the tray edge 205 (as in FIG. 2d).

The schematic diagram of FIG. 3b illustrates components of an irradiation system in accordance with principles of inventive concepts, and their relative positioning within housing 300. As previously described, an irradiation system in accordance with principles of inventive concepts may be used, for example, in the photoalignment of liquid crystal display panels. In this exemplary embodiment light source 301 is positioned above optics 302, which, in turn, are positioned above array 101. As previously indicated, these elements are fixed within housing 300 in such a way as to ensure that light from source 301 passes through optics 302 and on through array 101 before reaching samples 306 and that no light from source 301 reaches samples 306 through along any other path. In accordance with principles of inventive concepts, an elliptical reflector (not shown) may be positioned over light source 301 in order to redirect light through array 101.

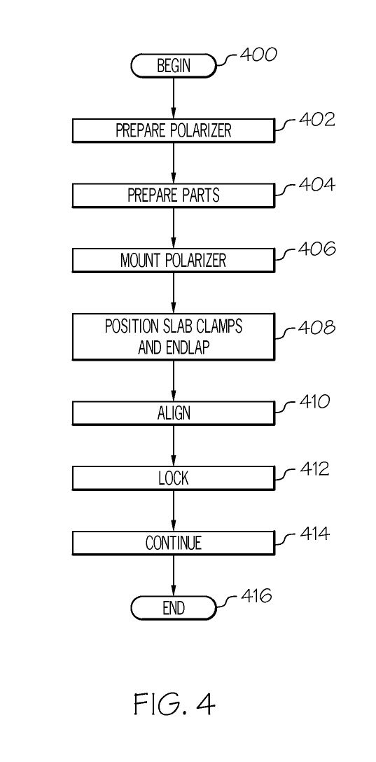

The flow chart of FIG. 4 will be used to describe an exemplary process in accordance with principles of inventive concepts by which a polarizer array in accordance with principles of inventive concepts may be formed. The process begins in step 400 and proceeds from there to step 402 each individual polarizer, such as polarizer 102, is prepared in a desired format. For example, a plurality of 63.5×67.5×3.0 mm polarizers 102 may be prepared with grating lines parallel to the long (e.g., 67.5 mm) edge. The orientation of each polarizer may be noted, for example, so that the back side of the polarizer 102 can be arranged to face the bottom of array.

From step 402 the process proceeds to step 404, where mechanical components for the array are prepared, for example, by aligning grating based polarizers, arranging top and bottom sides, and long and short axes, of polarizers according to principles of inventive concepts.

From step 404, the process proceeds to step 406, where a polarizer 102 is placed in a frame 104 to produce a frame-mounted polarizer 100. In an exemplary embodiment, the polarizer 102 is placed in a frame 104 in a manner to ensure that an edge of the polarizer 102 makes contact with the tray and the opposite edge is placed in contact with bar 108. The polarizer 102 may be situated to afford little or no contact between the lateral sides (that is, the longer sides) of the polarizer 102 and retainers 116, and with, for example, equal gaps between polarizer 102 and retainers 116 on either side.

From step 406 the process proceeds to step 408, where slab clamps 114 and end cap 106 are secured in position. After this step, the polarizer 102 may be handled without directly touching it. That is, the polarizer itself, 102, is isolated from handling and any external forces are directed to the frame, not the polarizer. As a result, the polarizer will remain aligned, even in the face of mechanical manipulation. The polarizer-mounted tray may then be loaded into a tray, for example, such as the tray 204 described in the discussion related to FIG. 2d.

From step 408, the process proceeds to step 410 where the polarizer, which has been loaded into a tray and the tray loaded into a frame, is aligned. The alignment process will be described in greater detail in the discussion related to FIG. 5. All of the polarizer-mounted trays are sequentially loaded into the frame and aligned, within the tolerances described above relative to the frame and relative to one another. Thread screws and/or micrometers may be employed to adjust the polarizers during the alignment process, as previously described.

From step 410, the process proceeds to step 412, where the polarizer-mounted tray is locked down after alignment, for example, by tightening screws passing from 112 in 100 to 104 as described in the discussion related to FIG. 2d.

From step 412 the process proceeds to step 414, where the next polarizer mounted tray is installed, aligned, and locked down to the frame, as just described. This process of loading, aligning, and locking polarizer-mounted trays repeats until all the trays are installed, aligned, and locked down in the frame, at which point the process proceeds to end in step 416.

An exemplary embodiment of an alignment process in accordance with principles of inventive concepts will be described in the discussion related to FIGS. 5 through 10. This description will focus primarily on the alignment of a first mounted polarizer and, for clarity and brevity of description, the polarizer, which may be referred to herein as the “master polarizer,” will be illustrated schematically, without accompanying tray or frame.

In the exemplary embodiment in accordance with principles of inventive concepts of FIG. 5, a collimated light beam of a randomly polarized visible range laser 501 is reflected by a UV hot mirror 502 towards a Glan-Taylor master polarizer 500. The Glan-Taylor master polarizer 500 splits the incident laser light beam 600 into two rays—the ordinary ray 601 is reflected while the extraordinary ray passes through the polarizer without reflection. The ordinary ray 601 is polarized in the direction perpendicular to the plane defined by rays 600 and 601, while the extraordinary ray is polarized in the direction parallel to the plane defined by rays 600 and 601. Therefore the ordinary ray 601 can be utilized to precisely determine the orientation of the master polarizer 500 and the direction of polarization which would pass through the master polarizer 500. A position-sensitive detector 503 is installed to record the direction of the reflected ray 601.

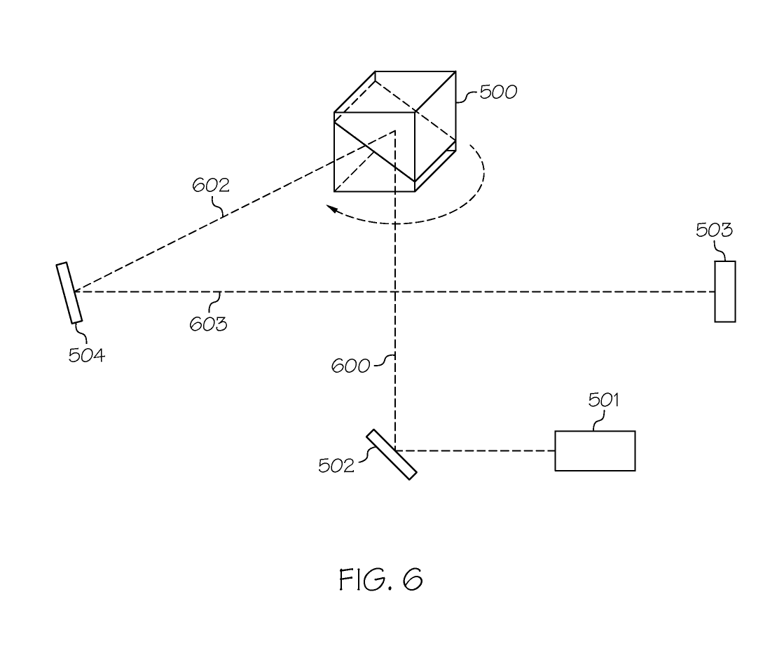

In the exemplary embodiment of FIG. 6, the master polarizer 500 is mounted on a rotary stage. In an exemplary embodiment, the incident beam 600 may be aligned to be parallel to the axis of rotation of the master polarizer 500. Additionally, the master polarizer 500 may be aligned so that its bottom surface is perpendicular to the incident beam 600. Following this alignment, once the master polarizer 500 is rotated 180°, an ordinary ray 602 lies in the plane initially defined by rays 600 and 601. The ray 602 is reflected by a semitransparent mirror 504 and propagates as an alignment ray 603 towards the position sensitive detector 503. The angular orientations (pitch and yaw) of the mirror 504 can be adjusted until the position-sensitive detector 503 shows the same readings as before the master polarizer 500 rotation in FIG. 1. This procedure assures that the alignment ray 603 lies in the plane which contains rays 600, 601, and 602. Therefore the direction of the alignment ray 603 is parallel to the direction of the polarization of light passing through the master polarizer 500 and the ray 603 can be used as a reference.

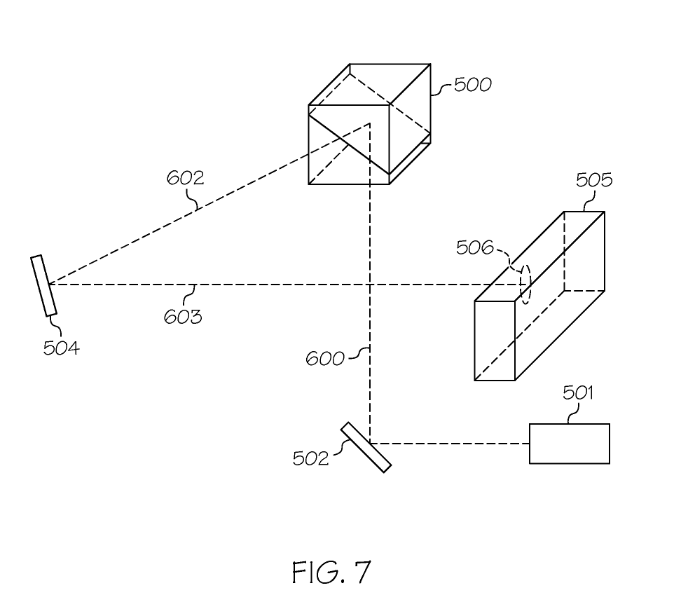

Referring now to the exemplary embodiment of FIG. 7, in order to couple the optical and the mechanical alignment of the instrument, an alignment bar 505 having one high flatness surface is installed such that its high flatness surface is faced towards the alignment ray 603. On the high flatness surface of the alignment bar 505 a small reflective surface 506 is machined by a suitable technique, such as single point diamond turning. In an exemplary embodiment, the reflective surface 506 is machined parallel to the high flatness surface of the alignment bar 505. The angular orientations (pitch and yaw) of the alignment bar 505 can be adjusted until the alignment ray 603 reflected form the surface 506 traces back along the directions of propagation of rays 603, 602, and 600 towards the laser 501. The back-tracing is ensured, for example, by using a small aperture between the laser 501 and the UV hot mirror 502, with the aperture size matching the laser beam diameter, and making the light reflected from the surface 506 pass though the aperture on its way back towards the laser 501. Once the back-tracing is achieved, the alignment bar 505 has its high flatness surface perpendicular to the alignment ray 603 and also perpendicular to the direction of polarization of light passing through the master polarizer 500,

In the exemplary embodiment of FIG. 8, as an alternative to machining the reflective surface 506, the alignment bar 505 can have a through hole 507 and a mirror 508 mounted at the alignment bar's side, opposite to the high flatness surface. The mirror is mounted so its reflective surface is faced towards the through hole 507 and is parallel to the high flatness surface of the alignment bar 505. The purpose of the mirror 508 is identical to the purpose of the reflective surface 506 and the alignment is identical to that described in the FIG. 7.

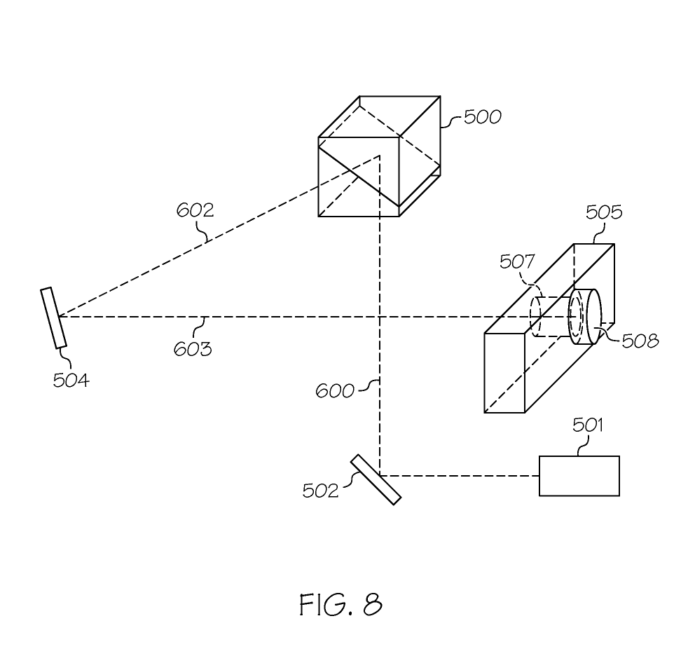

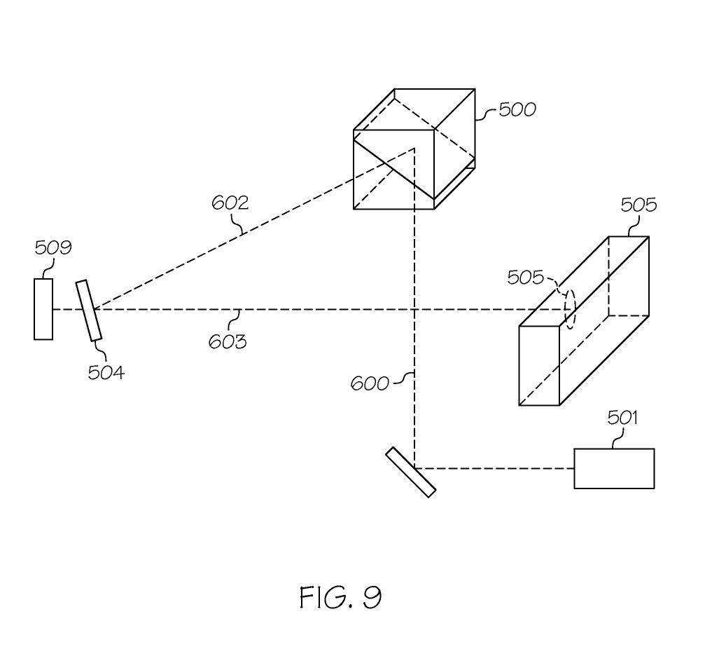

In the exemplary embodiment of FIG. 9, once the proper orientation of the alignment bar 505 is achieved, in order to simplify the future operation and control the long term stability of the alignment, a position-sensitive detector 509 may be installed behind the semitransparent mirror 504. The alignment ray 603 reflected from the reflective surface 506 is incident on the position sensitive detector 509. Changes in the reading from the detector 509 indicate the need to realign the angular orientations of the alignment bar 505.

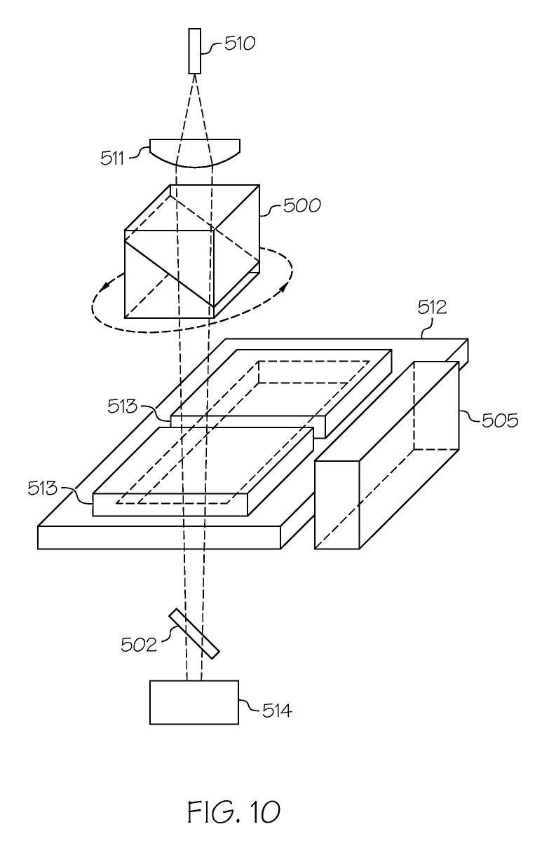

In the exemplary embodiment in accordance with principles of inventive concepts of FIG. 10A UV light source 510 and a collimating UV lens 511 are installed to have the randomly polarized UV light beam pass through the master polarizer 500, the UV hot mirror 502 and illuminate the light sensitive area of a detector 514. The intensity of the light source 510 is adjusted to keep the detector 514 in the linear range. A UV polarizer housing 512 with tiled UV polarizers 513 is then introduced in the UV beam path. The UV polarizer housing 512 has a high flatness surface which is brought in contact with the high flatness surface of the alignment bar 505 in order to ensure proper orientation of the UV polarizer housing. The azimuthal orientation of each UV polarizer 513 is achieved by (1) rotating the master polarizer 500 with small angular increments using a rotary stage with a high resolution encoder; (2) recording the UV light intensity at the detector 514 at every orientation of the master polarizer 500; (3) analyzing the recorded UV light intensity versus the master polarizer 500 orientation and calculating the required adjustment of the orientation of the polarizer 513; (4) adjusting the orientation of the UV polarizer 513 and repeating steps (1)-(3) to verify the alignment. Once the proper azimuthal orientation of a UV polarizer 513 is achieved, the UV polarizer housing 512 is slid along the alignment bar 505 so that another UV polarizer 513 is introduced in the UV light beam path and the procedure (1)-(4) is repeated until all UV polarizers 513 are aligned.

While inventive concepts have been particularly shown and described with reference to exemplary embodiments thereof, it will be apparent to those of ordinary skill in the art that various changes in form and detail may be made therein without departing from the spirit and scope of inventive concepts, as defined by the following claims.

What is claimed is:

1. An apparatus, comprising:
a polarizer;
a frame; and
a flexible mount coupling the polarizer to the frame.

2. The apparatus of claim 1, wherein the flexible mount comprises an expansion mechanism to apply force to at least one side of the polarizer and to thereby restrict movement of the polarizer within the frame.

3. The apparatus of claim 1 wherein the polarizer includes a grating.

4. The apparatus of claim 3 wherein the polarizer is a wire-grid polarizer.

5. The apparatus of claim 1 further comprising retention elements to position the polarizer within the frame.

6. The apparatus of claim 2, wherein the expansion mechanism includes a spring in compression configured to apply a force to the polarizer and to thereby hold the polarizer against the frame.

7. The apparatus of claim 6 further comprising a clamp to hold a side of the polarizer opposite the side of the polarizer to which the spring force is applied, and to thereby secure the polarizer within the frame.

8. An apparatus, comprising:
a rigid tray to accept frame-mounted polarizers;
a plurality of frame-mounted polarizers affixed to the tray, wherein each frame-mounted polarizer includes:
a polarizer;
a frame; and
a flexible mount coupling the polarizer to the frame.

9. The apparatus of claim 8, wherein the flexible mount comprises an expansion mechanism to apply force to at least one side of the polarizer and to thereby secure the polarizer within the frame.

10. The apparatus of claim 8, wherein the polarizer includes a grating.

11. The apparatus of claim 10, wherein the polarizer is a wire-grid polarizer.

12. The apparatus of claim 8, further comprising retention elements to position the polarizer within the frame.

13. The apparatus of claim 9, wherein the expansion mechanism includes a spring in compression configured to apply a force to the polarizer and to thereby hold the polarizer against the frame.

14. The apparatus of claim 13, further comprising a clamp to hold a side of the polarizer opposite the side of the polarizer to which the spring force is applied, and to thereby restrict the movement of the polarizer within the frame.

15. The apparatus of claim 8, wherein the frame-mounted polarizers are aligned within the rigid tray.

16. The apparatus of claim 8, wherein the rigid tray accommodates a one-dimensional, linear array of frame-mounted polarizers.

17. The apparatus of claim 8, wherein the rigid tray accommodates a two-dimensional, rectangular array of frame-mounted polarizers.

18. An apparatus, comprising:
a light source;
a housing including a reflector; and
a mosaic polarizer positioned within the housing, with the light source between itself and the reflector, the mosaic polarizer comprising:
a rigid tray to accept frame-mounted polarizers;
a plurality of frame-mounted polarizers affixed to and aligned within the tray, wherein each frame-mounted polarizer includes:
a polarizer;
a frame; and
a flexible mount coupling the polarizer to the frame.

19. The apparatus of claim 18, wherein the light source is configured to radiate ultraviolet light and the polarizers are wire-grid polarizers.

20. The apparatus of claim 19, wherein the mosaic polarizer includes a one-dimensional linear array of frame-mounted polarizers.
